(19) United States
(12) Patent Application Publication
(10) Pub. No.: US 2018/0225033 A1
(43) Pub. Date: Aug. 9, 2018

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masayuki ARATAKE, Kanagawa (JP); Chizuko SENTO, Kanagawa (JP)

(73) Assignee: FUJI XEROX CO., LTD., Tokyo (JP)

(21) Appl. No.: 15/689,929

(22) Filed: Aug. 29, 2017

(30) Foreign Application Priority Data
Feb. 8, 2017 (JP) 2017-021167

(51) Int. Cl. G06F 3/0484; H04L 29/08; G06F 3/0481; G06F 21/45

(52) U.S. Cl. CPC G06F 3/04847; G06F 21/45; G06F 3/0481; H04L 67/22

(57) ABSTRACT

An information processing apparatus includes a receiving unit, an acquisition unit, and a display. The receiving unit receives a setting operation performed by a user. The acquisition unit acquires prompt screen information based on lost status information generated from a history of the setting operation performed by the user. The display displays a prompt screen corresponding to the prompt screen information if the setting operation received by the receiving unit is a specific operation.

### CROSS-REFERENCE TO RELATED APPLICATIONS

This application is based on and claims priority under 35 USC 119 from Japanese Patent Application No. 2017-021167 filed Feb. 8, 2017.

### BACKGROUND

### Technical Field

The present invention relates to an information processing apparatus and a non-transitory computer readable medium.

### SUMMARY

According to an aspect of the invention, there is provided an information processing apparatus including a receiving unit, an acquisition unit, and a display. The receiving unit receives a setting operation performed by a user. The acquisition unit acquires prompt screen information based on lost status information generated from a history of the setting operation performed by the user. The display displays a prompt screen corresponding to the prompt screen information if the setting operation received by the receiving unit is a specific operation.

### BRIEF DESCRIPTION OF THE DRAWINGS

An exemplary embodiment of the present invention will be described in detail based on the following figures, wherein:

FIG. 1 is a diagram of an example configuration of the conceptual modules of the exemplary embodiment;

FIGS. 2A and 2B are explanatory diagrams illustrating an example configuration of a system using the exemplary embodiment;

FIGS. 3A and 3B are explanatory diagrams each illustrating an example of a menu that is user-unfriendly because the exemplary embodiment is not used;

FIGS. 4A and 4B are explanatory diagrams each illustrating an example of a menu that is user-unfriendly because the exemplary embodiment is not used;

FIGS. 5A and 5B are explanatory diagrams each illustrating an example of a menu that is user-unfriendly because the exemplary embodiment is not used;

FIGS. 6A and 6B are explanatory diagrams each illustrating an example of a menu that is user-unfriendly because the exemplary embodiment is not used;

FIG. 7 is an explanatory diagram illustrating an example of a menu that is user-unfriendly because the exemplary embodiment is not used;

FIG. 8 is a flowchart illustrating an example of a process according to the exemplary embodiment;

FIG. 9 is an explanatory table illustrating an example data structure of a history-information table;

FIG. 10 is an explanatory table illustrating an example data structure of a lost-status-information table;

FIG. 11 is a flowchart illustrating an example of a process according to the exemplary embodiment;

FIGS. 12A and 12B are explanatory diagrams illustrating examples of the process according to the exemplary embodiment;

FIGS. 13A, 13B, and 13C are explanatory diagrams illustrating examples of the process according to the exemplary embodiment;

FIG. 14 is an explanatory table illustrating an example data structure of a prompt screen;

FIGS. 15A and 15B are explanatory diagrams illustrating examples of the process according to the exemplary embodiment;

FIGS. 16A, 16B, and 16C are explanatory diagrams illustrating examples of the process according to the exemplary embodiment;

FIGS. 17A and 17B are explanatory diagrams illustrating examples of the process according to the exemplary embodiment;

FIGS. 18A, 18B, and 18C are explanatory diagrams illustrating examples of the process according to the exemplary embodiment;

FIGS. 19A, 19B, and 19C are explanatory diagrams illustrating examples of the process according to the exemplary embodiment;

FIGS. 20A and 20B are explanatory diagrams illustrating examples of the process according to the exemplary embodiment;

FIG. 21 is an explanatory diagram illustrating an example of the process according to the exemplary embodiment; and

FIG. 22 is a block diagram illustrating an example hardware configuration of a computer implementing the exemplary embodiment.

### DETAILED DESCRIPTION

Hereinafter, an example of an exemplary embodiment to implement the invention will be described with reference to the drawings.

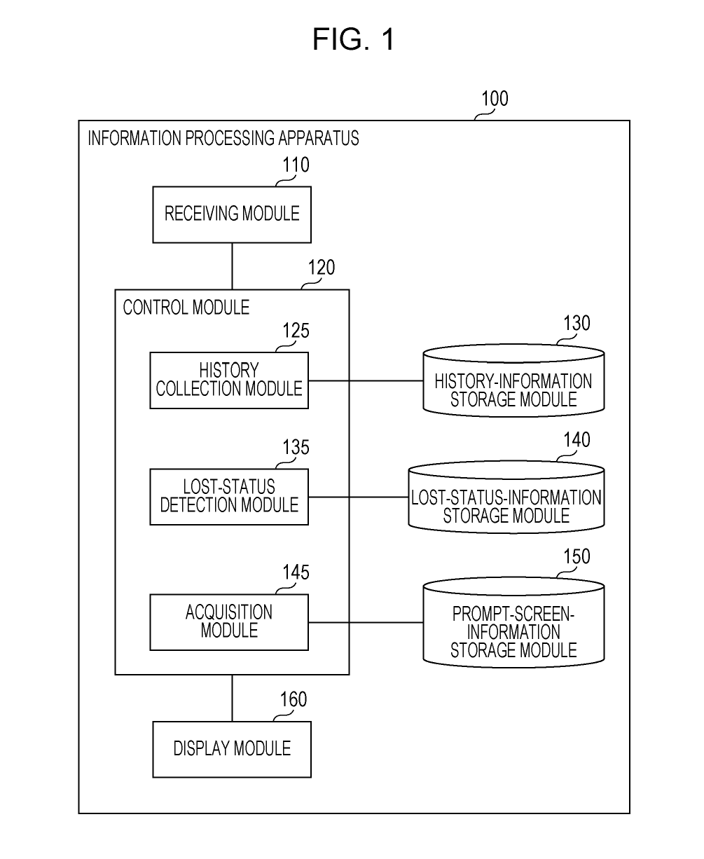

FIG. 1 is a diagram of an example configuration of the conceptual modules of the exemplary embodiment.

Note that the term “module” refers to generally logically separable components of software (computer programs) and hardware or the like. Modules in the exemplary embodiment thus refer to not only modules in a computer program but also modules in a hardware configuration. Accordingly, the description of the exemplary embodiment also serves as a description of a computer program for causing a computer to function as the modules (a program for causing a computer to execute steps, a program for causing a computer to function as components, and a program for causing a computer to implement functions) as well as a system and a method therefor. Meanwhile, the term “to store” and other terms equivalent to “to store” are used in descriptions. In a case where the exemplary embodiment describes a computer program, the term means storing something in a storage device or controlling something so as to store something in a storage device. The modules are provided for respective functions on a one-to-one basis. However, in implementing the functions, one program may constitute one module; one program may constitute multiple modules; and multiple programs may constitute one module. In addition, one computer may run multiple modules, and multiple computers may run one module in a distributed or parallel processing environment. Note that one module may include another module. Moreover, the term “connection” is used for not only a physical connection but also a logical connection (such as data exchange, instructions, or a reference relationship among data pieces). The term “predetermined” refers to having been determined before target processing. This term is used in such a manner as to include the meaning of being determined according to the situation at the determination time or to the situation thus far only before target processing, regardless of whether before or even after the start of processing in the exemplary embodiment. Meanwhile, in a case of multiple “predetermined values”, the values may be different from one another, or two or more of the values may be the same (including all of the values). Moreover, an expression meaning “if A, then B” is used in such a manner as to mean that “it is determined whether A holds true, and if it is determined that A holds true, then B is performed”. However, this excludes a case where the determination of whether A holds true is not needed.

A system or a device includes not only a configuration in which multiple computers, hardware, devices, and the like are connected to each other through a communication unit such as a network (including a communication connection on a one-to-one basis), but also a configuration in which a computer, hardware, a device, or the like is implemented. The terms “device” and “system” are used as terms having the same meaning. It goes without saying that the “system” does not include a mere social “system” built in accordance with agreements worked out by humans.

In addition, to perform a processing operation or multiple processing operations in each module, the module reads target information from a storage device for each processing, performs the processing, and writes a processing result to the storage device. Accordingly, explanations of reading the content from the storage device before processing and writing the content to the storage device after the processing are omitted in some cases. Here, the storage device may include a hard disk, a random access memory (RAM), an external storage medium, a storage device connected through a communication network, a register in a CPU, and other devices.

An information processing apparatus 100 that is the exemplary embodiment displays a prompt screen on which a user performing an operation for setting an item in an apparatus is prompted to proceed to a target item. As illustrated in the example in FIG. 1, the information processing apparatus 100 includes a receiving module 110, a control module 120, a history-information storage module 130, a lost-status-information storage module 140, a prompt-screen-information storage module 150, and a display module 160.

Any apparatus may herein be used as long as the user needs to set an item in the apparatus. For example, examples of the apparatus may include an image processing apparatus such as a copier, a fax machine, a scanner, a printer, a multifunction printer (an image processing apparatus having two or more functions of a scanner, a printer, a copier, a fax machine, and other devices), a personal computer, a mobile telecommunication device (including a mobile phone, a smartphone, a mobile device, a wearable computer, and other devices), a personal digital electronics, a robot, and other devices. Hereinafter, an image processing apparatus will be described as an example. Examples of an item set in the image processing apparatus by a user include password change for an administrator, password change for the image processing apparatus, shortcut key setting, and power-save mode change.

Without the exemplary embodiment, the user may not be able to understand how to set an item, and a setting operation may be time consuming (or may end in failure).

Specifically, when an administrator selects administrator mode and performs a setting operation (such as setting a shortcut key on the top screen, changing the administrator password, or changing user authentication), it takes time to reach a target setting item.

This is due to such a complex hierarchical structure causing a user to become lost in the hierarchy, the button that needs to be selected first not being easy to find (i.e., the entry point not being easy to find), or the like.

In particular, a system allowing any user to serve as an administrator is provided in the small and medium business (SMB) market, and it may take a novice administrator a long time to perform a setting operation in such a system.

The receiving module 110 is connected to the control module 120. The receiving module 110 receives a user operation (including a setting operation). For example, the receiving module 110 controls a liquid crystal display also serving as a touch panel and receives a user operation. Aside from this, a user operation performed with a mouse, a keyboard, a camera, a microphone, or the like (including a face, a line of sight, a gesture, a vocal utterance, and the like) may also be received. In addition, face recognition (including expression recognition), line-of-sight detection, gesture recognition, speech recognition, or the like may be performed to recognize an operation.

The control module 120 includes a history collection module 125, a lost-status detection module 135, and an acquisition module 145 and is connected to the receiving module 110 and the display module 160. The control module 120 acquires prompt screen information in accordance with a setting operation received by the receiving module 110 and delivers the prompt screen information to the display module 160.

The history collection module 125 is connected to the history-information storage module 130. The history collection module 125 collects histories of user operations (including a setting operation) and stores the histories in the history-information storage module 130.

The history-information storage module 130 is connected to the history collection module 125 of the control module 120. The history-information storage module 130 stores therein the histories collected by the history collection module 125, such as a history-information table 900 illustrated in FIG. 9 (described later).

The lost-status detection module 135 is connected to the lost-status-information storage module 140. The lost-status detection module 135 detects whether the user is lost during the setting operation. The lost-status detection module 135 stores information regarding the lost status (hereinafter, also referred to as lost status information) in the lost-status-information storage module 140.

The lost-status detection module 135 determines that the user is lost when detecting, for example, one of the following states after the setting operation is performed.

(1) a predetermined time elapses without any user operation;
(2) the total time taken for setting after the start of the setting operation reaches a predetermined time;
(3) a return operation is detected on a predetermined layer screen, specifically, a “Back” button is selected;
(4) a return operation is detected a predetermined number of times or more;
(5) a line of sight/finger movement indicating that the user is lost is detected, specifically, by performing matching between a result of line-of-sight detection or gesture recognition and a predetermined pattern (a pattern of a line of sight or finger movement observed in a case where the user is lost);
(6) a frown or the like is detected, specifically, in such a manner that an area of a face (such as the middle of the forehead or the eyes) are extracted from a face image captured with a camera, and matching with a predetermined pattern (a characteristic of an image of the area observed in a case where the user is lost) is performed; and
(7) a predetermined vocal utterance is detected, specifically, based on whether a result of speech recognition corresponds to a predetermined character string (such as “oops”).

It goes without saying that a combination of these may be detected.

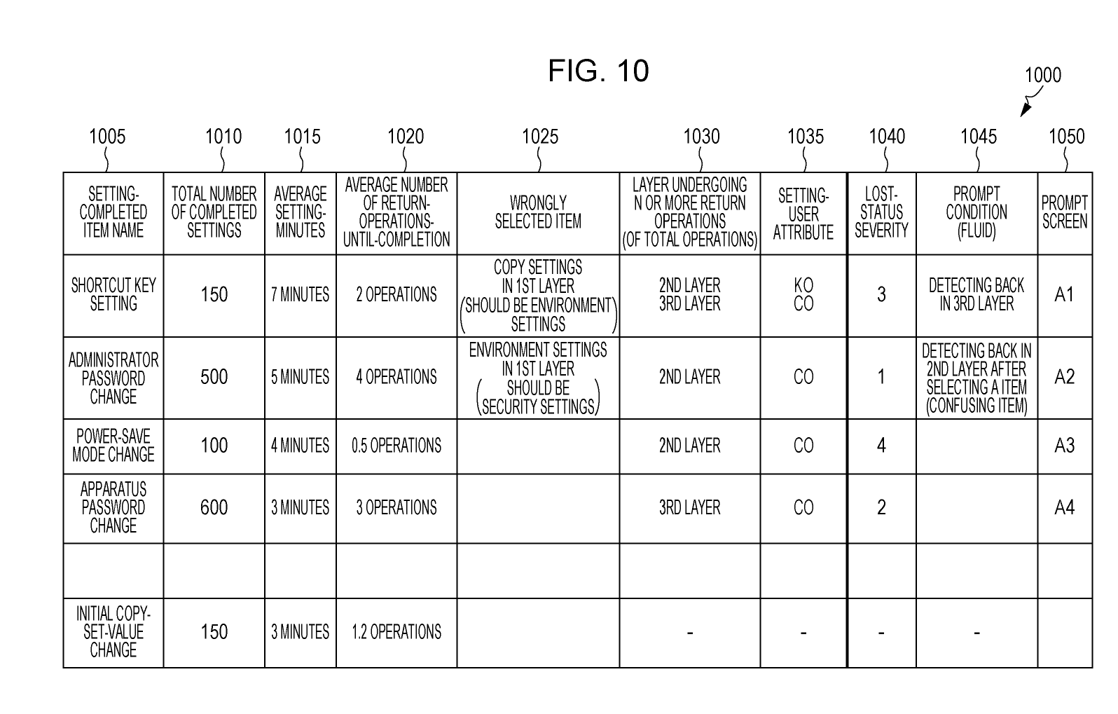

The lost-status-information storage module 140 is connected to the lost-status detection module 135 of the control module 120. The lost-status-information storage module 140 stores therein information regarding a lost status detected by the lost-status detection module 135, such as a lost-status-information table 1000 illustrated in FIG. 10 (described later).

The acquisition module 145 is connected to the prompt-screen-information storage module 150. The acquisition module 145 acquires prompt screen information based on lost status information generated from the history of setting operations performed by the user. The lost status information is based on at least one of a screen on which a return operation is performed, a return operation count, and a time taken until setting completion, or is based on a combination of any one of the screen, the return operation count, and the time. The “lost status information” is information regarding multiple operations each considered to indicate that a user is lost. Examples of the information include information regarding a screen likely to cause a user to get lost and information regarding the number of times a “Back” button is selected until the user reaches the target item. The “prompt screen information” is information regarding a screen on which the user performing a setting operation is prompted to reach a target item and information regarding a condition for displaying the screen.

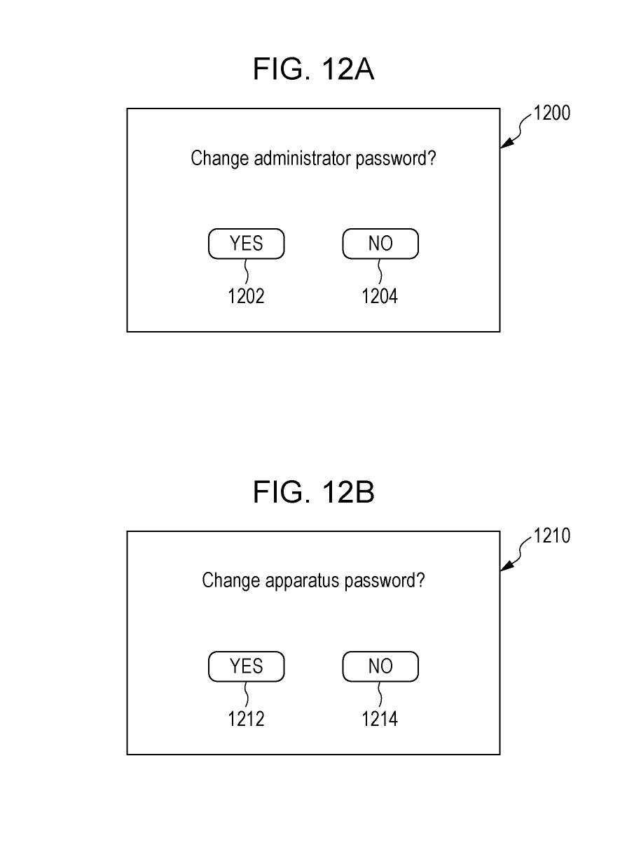

The prompt-screen-information storage module 150 is connected to the acquisition module 145 of the control module 120. The prompt-screen-information storage module 150 stores therein prompt screen information. For example, the prompt-screen-information storage module 150 stores therein a prompt screen 1200 and the like that is illustrated in FIGS. 12A and 12B (described later). Note that prompt screens may be hierarchized. The hierarchized prompt screens will be described later by using the example in FIG. 14.

The display module 160 is connected to the control module 120. If a setting operation received by the receiving module 110 is a specific operation, the display module 160 displays a prompt screen corresponding to prompt screen information. The “prompt screen” is a screen on which a user performing a setting operation is prompted to reach a target item.

In addition, if a return operation is performed on a screen in a specific layer, the display module 160 may display a prompt screen.

The display module 160 may also display a prompt screen in a question form and may change the order of questions in the question form in accordance with lost status information.

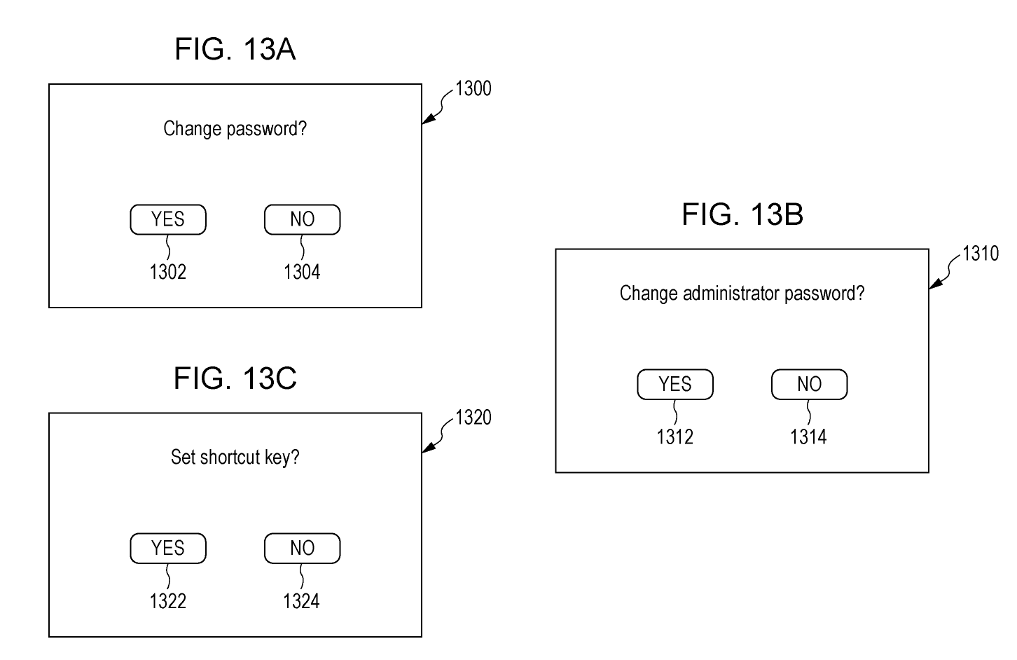

If the user refuses the prompt on a displayed prompt screen, the display module 160 may skip a prompt screen belonging to a group at a lower level than the level of the prompt screen including the refused prompt and display a subsequent prompt screen. This will be described later using the example in FIG. 13.

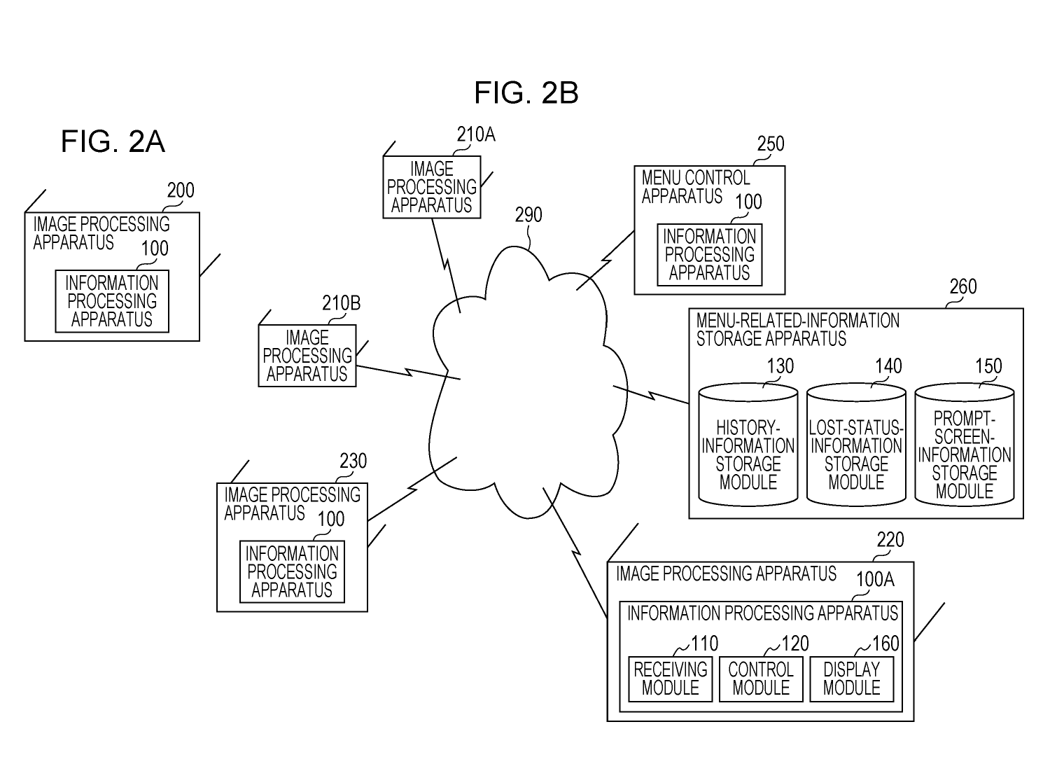

FIGS. 2A and 2B are explanatory diagrams illustrating an example configuration of a system using the exemplary embodiment.

An image processing apparatus 200 is configured as a standalone apparatus in the example in FIG. 2A and includes the information processing apparatus 100. Without a communication network, the image processing apparatus 200 is capable of displaying a prompt screen when the user performs a setting operation. For example, in a case where the user is lost when changing the administrator password, the image processing apparatus 200 displays a prompt screen.

A system is established through a network in the example in FIG. 2B, and an image processing apparatus 210A, an image processing apparatus 210B, an image processing apparatus 220, an image processing apparatus 230, a menu control apparatus 250, and a menu-related-information storage apparatus 260 are connected to each other through a communication network 290. The communication network 290 may be a wired network, a wireless network, or a combined network of these and may be, for example, the Internet serving as a communication infrastructure, an intranet, or the like.

The menu control apparatus 250 includes the information processing apparatus 100. The function of the menu control apparatus 250 may be implemented as a cloud service. The menu control apparatus 250 collects histories of operations from the image processing apparatuses 210A, 210B, 220, and 230. Upon detecting a lost status of the user in a setting operation in one of the image processing apparatuses 210A, 210B, 220, and 230, the menu control apparatus 250 transmits prompt screen information. This enables even the image processing apparatus 210A or other image processing apparatuses without the information processing apparatus 100 to display a prompt screen. In this case, the aforementioned phrase “the display module 160 displays a prompt screen” corresponds to transmitting prompt screen information to the image processing apparatus 210A or other image processing apparatuses and controlling the image processing apparatus 210A or other image processing apparatuses to display the corresponding prompt screen.

The image processing apparatus 220 includes an information processing apparatus 100A. The information processing apparatus 100A includes the receiving module 110, the control module 120, and the display module 160. The menu-related-information storage apparatus 260 includes the history-information storage module 130, the lost-status-information storage module 140, and the prompt-screen-information storage module 150. Specifically, the menu-related-information storage apparatus 260 collects histories of operations from the image processing apparatuses 210A, 210B, 220, and 230 and manages the history-information storage module 130, the lost-status-information storage module 140, and the prompt-screen-information storage module 150. The menu-related-information storage apparatus 260 transmits prompt screen information to the image processing apparatus 220 with the history-information storage module 130, the lost-status-information storage module 140, and the prompt-screen-information storage module 150 being in an updated state.

The image processing apparatus 230 includes the information processing apparatus 100. The information processing apparatus 100 of the image processing apparatus 230 may update the lost-status-information storage module 140 and the display module 160 in such a manner as to communicate with the menu control apparatus 250 or the menu-related-information storage apparatus 260. Alternatively, the image processing apparatus 230 may implement the function of the menu control apparatus 250 for the image processing apparatus 210A and other image processing apparatuses.

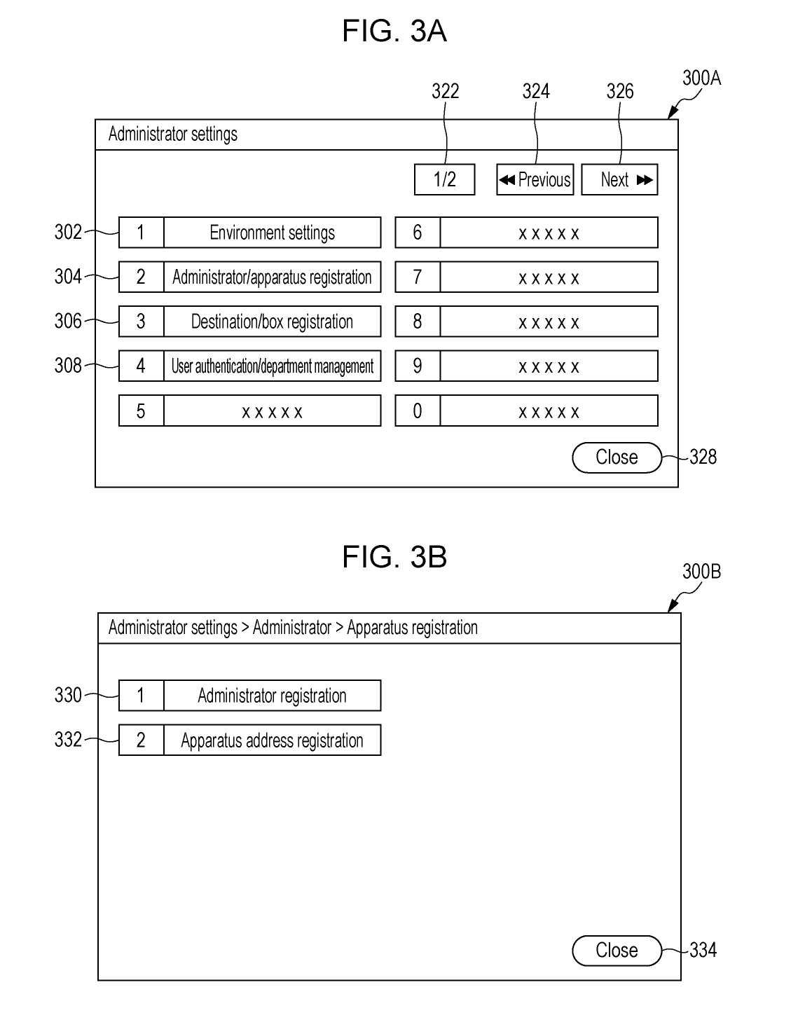

FIGS. 3A to 7 illustrate examples of menus that are user-unfriendly because the exemplary embodiment is not used. In the examples, an administrator intends to change an administrator password on an administrator settings screen.

On a first-layer screen 300A illustrated in the example in FIG. 3A, menu items such as an environment settings button 302, an administrator/apparatus registration button 304, a destination/box registration button 306, a user authentication/department management button 308, a current-page display area 322, a Previous button 324, a Next button 326, and a Close button 328 are displayed. The menu may also include “copy settings”, “printing settings”, “fax settings”, and other settings. In this case, the administrator considers the administrator/apparatus registration button 304 to be an appropriate button to change the administrator password on the first-layer screen 300A and thus selects the administrator/apparatus registration button 304.

In response, a second-layer screen 300B illustrated in the example in FIG. 3B appears. On the second-layer screen 300B, a menu including an administrator registration button 330 and an apparatus address registration button 332 and a Close button 334 are displayed. Since the administrator intends to change the administrator password, the administrator considers the administrator registration button 330 on the second-layer screen 300B to be an appropriate button and thus selects the administrator registration button 330.

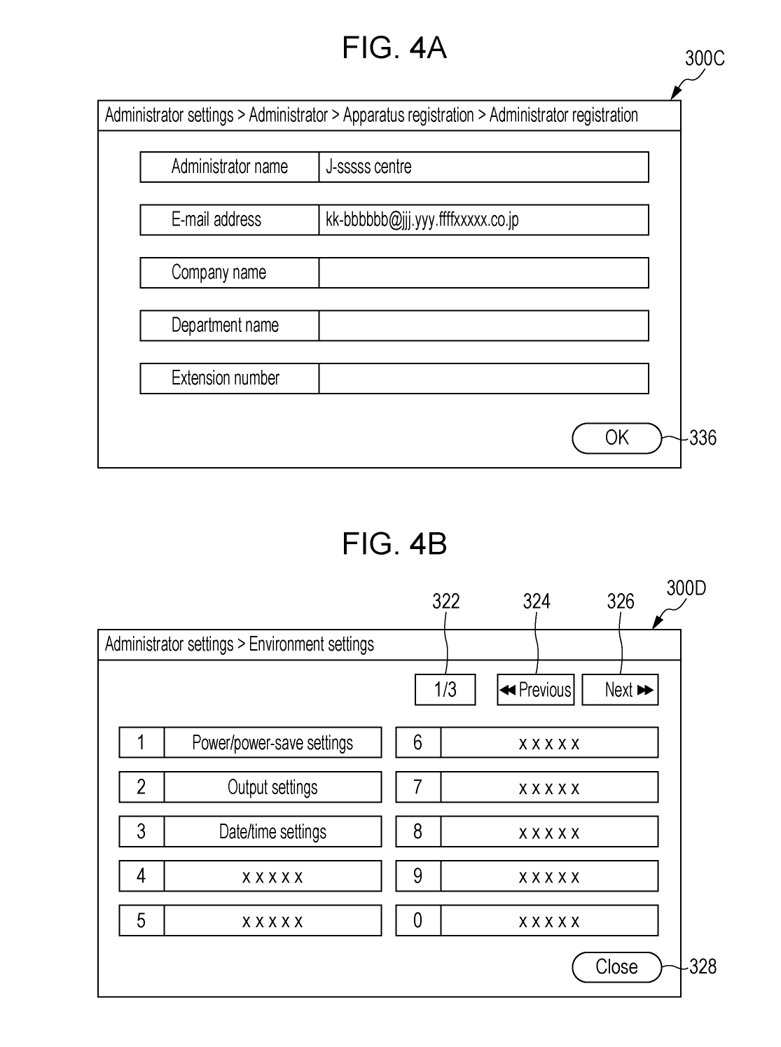

In response, a third-layer screen 300C illustrated in the example in FIG. 4A appears. On the third-layer screen 300C, an administrator name field, an e-mail address field, a company name field, a department name field, an extension number field, and an OK button 336 are displayed. An administrator name, an e-mail address, a company name, a department name, and an extension number are respectively displayed in the administrator name field, the e-mail address field, the company name field, the department name field, and the extension number field. The third-layer screen 300C is the final screen, and it proves that the administrator has not reached a screen for administrator password change.

If the OK button 336 is selected, the screen returns to the second-layer screen 300B. The second-layer screen 300B illustrated in the example in FIG. 3B has the Close button 334 in its lower right part. If the Close button 334 is selected, the screen returns to the first-layer screen 300A illustrated in the example in FIG. 3A. That is, the screen returns to the initial screen. The administrator further and again searches for the entry point for the administrator password change.

The administrator considers the environment settings button 302 to be an appropriate button to change the administrator password on the first-layer screen 300A and thus selects the environment settings button 302.

In response, a second-layer screen 300D illustrated in the example in FIG. 4B appears. On the second-layer screen 300D, a menu including a power/power-save settings button, an output settings button, and a date/time settings button, the current-page display area 322, the Previous button 324, the Next button 326, and the Close button 328 are displayed. It proves that a menu for the administrator password change is not present. In addition, since the current-page display area 322 indicates that there are three pages started with the second-layer screen 300D, the Next button 326 in the upper right part of the screen is selected to proceed to the next page.

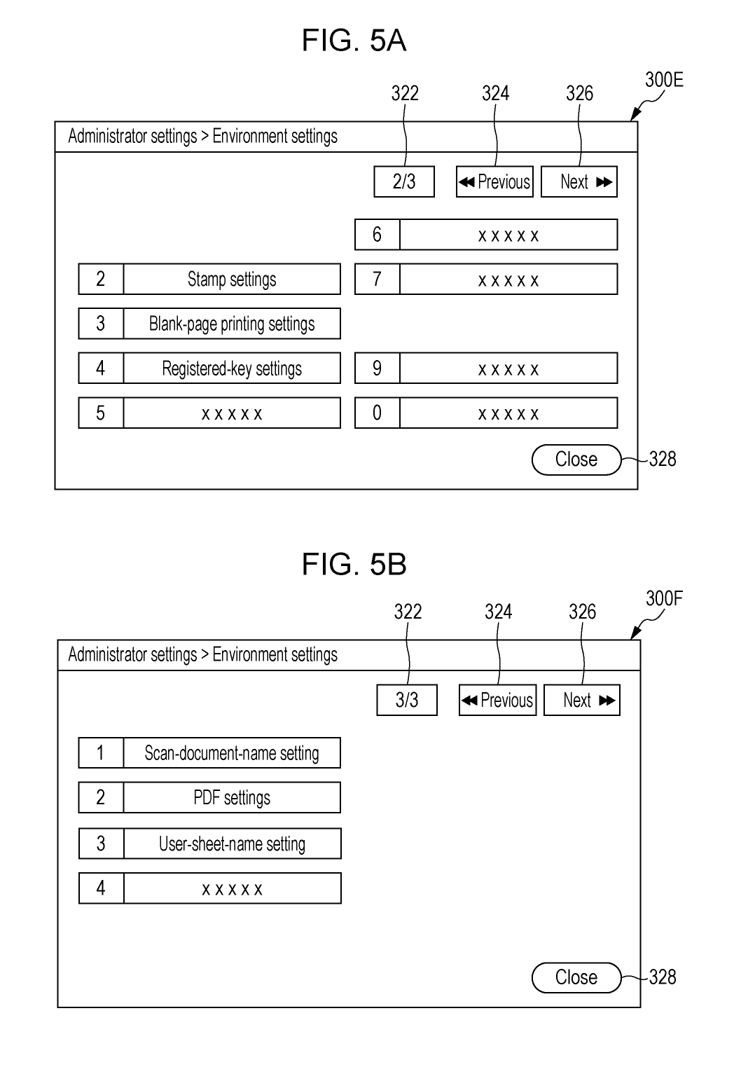

In response, a second-layer screen 300E illustrated in the example in FIG. 5A appears. On the second-layer screen 300E, a menu including a stamp settings button, a blank-page printing settings button, and a registered-key settings button, the current-page display area 322, the Previous button 324, the Next button 326, and the Close button 328 are displayed. It proves that the menu for the administrator password change is not present, and the Next button 326 in the upper right part is selected to proceed to the next page.

In response, a second-layer screen 300F illustrated in the example in FIG. 5B appears. On the second-layer screen 300F, a menu including a scan-document-name setting button, a PDF settings button, and a user-sheet-name setting button, the current-page display area 322, the Previous button 324, the Next button 326, and the Close button 328 are displayed. It proves that the menu for the administrator password change is not present. After all, the Close button 328 is selected, and the screen returns to the first-layer screen 300A illustrated in the example in FIG. 3A. At this time point, two selection operations are wrongly performed on the first-layer screen 300A.

Since the current-page display area 322 indicates that there are two pages started with the first-layer screen 300A, the Next button 326 in the upper right part is selected to proceed to the next page.

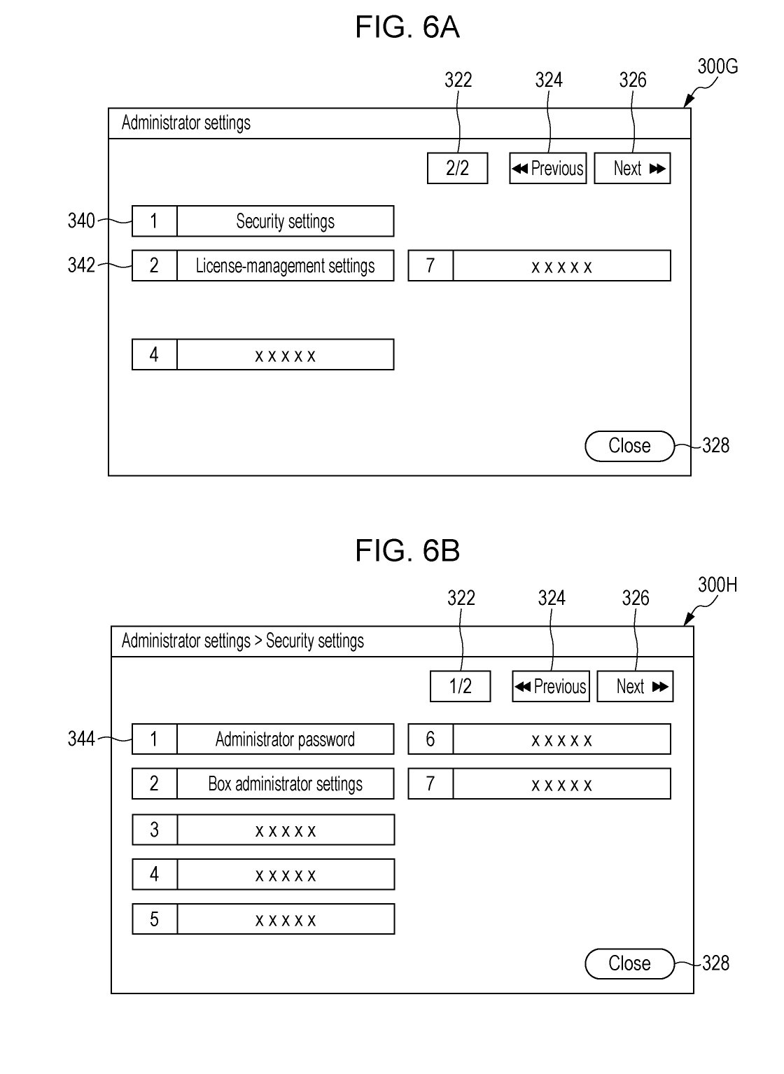

In response, a first-layer screen 300G illustrated in the example in FIG. 6A appears. On the first-layer screen 300G, a menu including a security settings button 340 and a license-management settings button 342, the current-page display area 322, the Previous button 324, the Next button 326, and the Close button 328 are displayed. Since the security settings button 340 is provided on the first-layer screen 300G and the password change has a security aspect, the administrator considers the security settings button 340 to be an appropriate button and thus selects the security settings button 340.

In response, a second-layer screen 300H illustrated in the example in FIG. 6B appears. On the second-layer screen 300H, a menu including an administrator password button 344 and a box administrator settings button, the current-page display area 322, the Previous button 324, the Next button 326, and the Close button 328 are displayed. The administrator finds and selects the administrator password button 344.

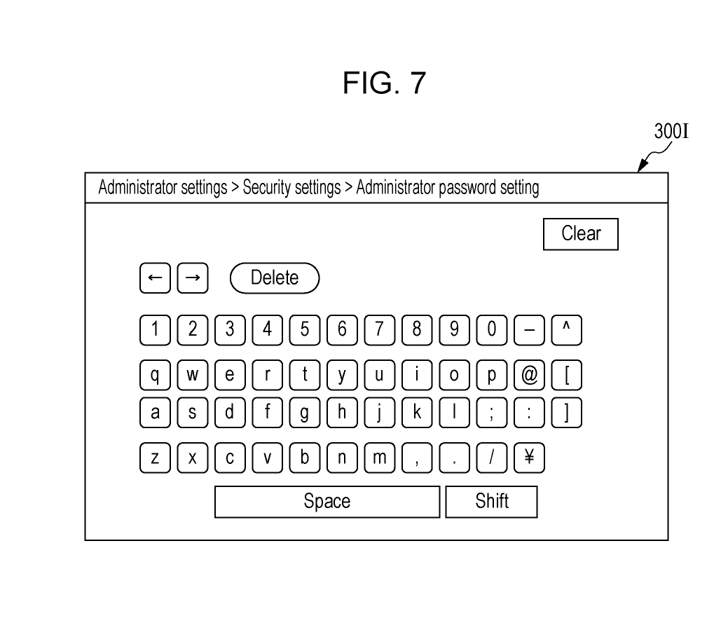

In response, a third-layer screen 300I illustrated in the example in FIG. 7 appears. The administrator reaches the screen for administrator password change at long last. Eight unnecessary screens have been displayed. It goes without saying that the same is likely to occur in other setting operations (such as setting a shortcut key for setting parameters in advance for copying or scanning).

In the exemplary embodiment, if a “Close button” (button indicating returning to the previous screen) is selected, for example, two times, a prompt screen is displayed.

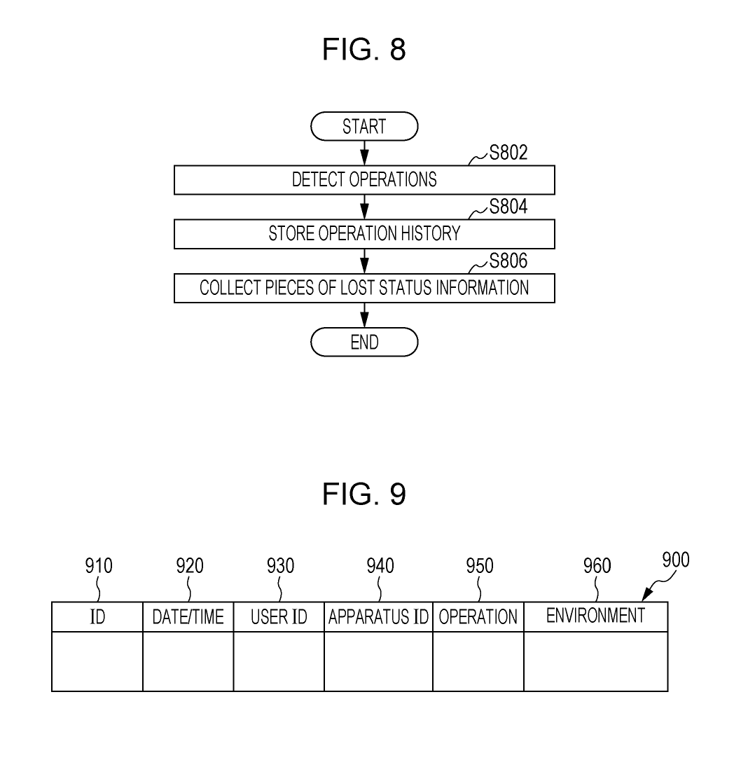

FIG. 8 is a flowchart illustrating an example of a process according to the exemplary embodiment, that is, an example of a process for generating the lost-status-information table 1000.

In step S802, operations performed on an apparatus (such as the image processing apparatus 200) are detected.

In step S804, an operation history is stored. For example, the history-information table 900 is generated. FIG. 9 is an explanatory table illustrating an example data structure of the history-information table 900. The history-information table 900 has an identification (ID) column 910, a date/time column 920, a user ID column 930, an apparatus ID column 940, an operation column 950, and an environment column 960. The ID column 910 is used to store ID information for uniquely identifying a performed operation in the exemplary embodiment. The date/time column 920 is used to store a date and time. The user ID column 930 is used to store information (a user ID) for uniquely identifying a user in the exemplary embodiment. The apparatus ID column 940 is used to store information (an apparatus ID) for uniquely identifying an apparatus in the exemplary embodiment. The operation column 950 is used to store an operation. The environment column 960 is used to store an environment.

In step S806, pieces of lost status information are collected. The pieces of lost status information are collected from operations performed until a setting operation is performed after a setting operation screen (such as the above-described first-layer screen 300A illustrated in the example in FIG. 3A) is displayed. For example, the lost-status-information table 1000 is generated as the pieces of lost status information. FIG. 10 is an explanatory table illustrating an example data structure of the lost-status-information table 1000. The lost-status-information table 1000 has a setting-completed item name column 1005, a total number of completed settings column 1010, an average setting-minutes column 1015, an average number of return-operations-until-completion column 1020, a wrongly selected item column 1025, a layer undergoing N or more return operations (of total operations) column 1030, a setting-user attribute column 1035, a lost-status severity column 1040, a prompt condition column 1045, and a prompt screen column 1050. The setting-completed item name column 1005 is used to store the name of an item a setting operation for which is complete. The total number of completed settings column 1010 is used to store the number of times a setting operation is complete. The average setting-minutes column 1015 is used to store an average of minutes taken for a setting operation. The average number of return-operations-until-completion column 1020 is used to store an average of the number of times a return operation is performed until setting completion. The wrongly selected item column 1025 is used to store a wrongly selected item. The layer undergoing N or more return operations (of total operations) column 1030 is used to store a layer in which N or more return operations (of the total operations) are performed. The setting-user attribute column 1035 is used to store the attribute of a user who performs a setting operation. The lost-status severity column 1040 is used to store lost status severity. The prompt condition column 1045 is used to store a condition for displaying a prompt screen. The prompt screen column 1050 is used to store a prompt screen (such as the prompt screen 1200 illustrated in FIG. 12A).

Note that the lost-status severity column 1040, the prompt condition column 1045, and the prompt screen column 1050 are generated by using pieces of information in columns from the setting-completed item name column 1005 to the setting-user attribute column 1035. A value in the lost-status severity column 1040 indicates the degree of lost status severity (in this case, the smaller the value, the more likely the user is to be lost). The value in the lost-status severity column 1040 may be determined in accordance with, for example, a value in the corresponding row in the average number of return-operations-until-completion column 1020.

The prompt condition column 1045 may be generated by using machine learning or the like. Specifically, deep learning or the like may be used. As performed setting operations are accumulated in the history, values in the lost-status severity column 1040, the prompt condition column 1045, and the prompt screen column 1050 may be changed.

If a condition for displaying a prompt screen in the prompt condition column 1045 is satisfied, a corresponding prompt screen in the prompt screen column 1050 is triggered. Note that an item name in the setting-completed item name column 1005 may be used for a message on the prompt screen in the prompt screen column 1050. Specifically, the message may be a question based on an item name in the setting-completed item name column 1005.

The lost-status-information table 1000 is not limited to the example in FIG. 10. For example, the lost-status-information table 1000 may include a layer in which a user stays for a long time and, as the attribute of a user such as professionality (key operator (KO) (professional operator) and casual operator (CO) (general user)), sex, age, size of a company, and the like of the user. The lost-status-information table 1000 may also include a country where a target apparatus is installed, size of a company where the apparatus is installed, and the like.

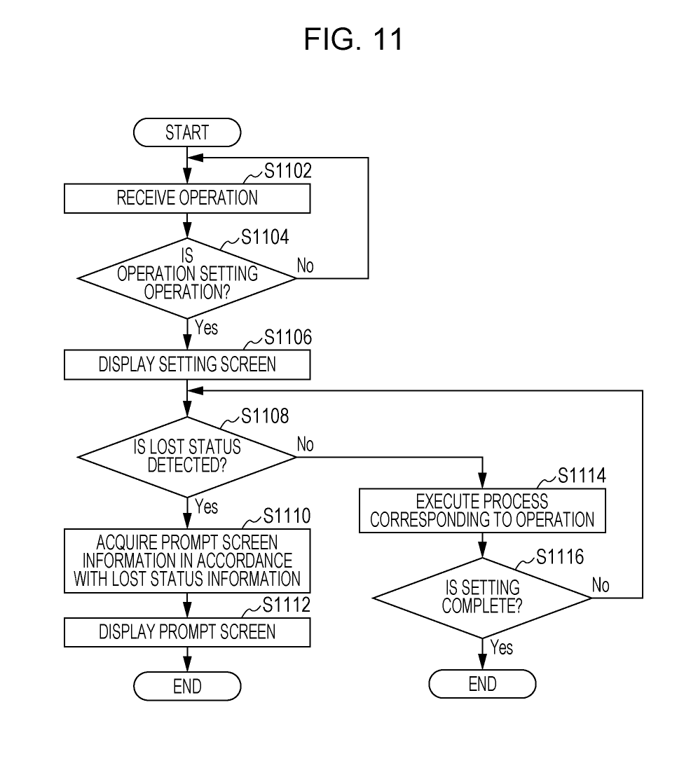

FIG. 11 is a flowchart illustrating an example of a process according to the exemplary embodiment.

In step S1102, an operation is received.

In step S1104, it is determined whether the operation is a setting operation. If the operation is a setting operation, the process proceeds to step S1106. In the other cases, a process corresponding to the operation is executed.

In step S1106, a settings screen is displayed, such as the first-layer screen 300A illustrated in the example in FIG. 3A.

In step S1108, it is determined whether a lost status of a user is detected. If the lost status is detected, the process proceeds to step S1110. In the other cases (in a case where a prompt screen does not need to be displayed), the process proceeds to step S1114.

In step S1110, prompt screen information is acquired in accordance with the lost status information. Specifically, it is determined whether the operation satisfies a condition in the prompt condition column 1045 of the lost-status-information table 1000.

In step S1112, the prompt screen is displayed. Steps S1110 and S1112 will be described in more detail with reference to FIG. 12A and succeeding drawings.

In step S1114, a process corresponding to the operation is executed.

In step S1116, it is determined whether setting is complete. If setting is complete, the process is terminated (step S1198). In the other cases, the process returns to step S1108.

FIGS. 12A and 12B are explanatory diagrams illustrating examples of the process according to the exemplary embodiment. In the examples, if a lost status is detected, a prompt screen is displayed in accordance with the lost-status severity column 1040 of the lost-status-information table 1000. Specifically, if a lost status is detected, a setting item corresponding to a small value in the lost-status severity column 1040 is extracted, and a prompt screen for the setting item is displayed.

A message “Change administrator password?” is displayed on the prompt screen 1200. A YES button 1202 and a NO button 1204 are also displayed. Specifically, a prompt screen provided for the first-rate lost status severity is displayed.

If the YES button 1202 is selected, a screen for administrator password change is displayed. If the NO button 1204 is selected, a prompt screen 1210 illustrated in the example in FIG. 12B is displayed.

A message “Change apparatus password?” is displayed on the prompt screen 1210. A YES button 1212 and a NO button 1214 are also displayed. Specifically, a prompt screen provided for the second-rate lost status severity is displayed.

If the YES button 1212 is selected, a screen for apparatus password change is displayed. If the NO button 1214 is selected, a prompt screen for “Shortcut key setting” of the third-rate lost status severity is displayed.

FIGS. 13A to 13C are explanatory diagrams illustrating examples of the process according to the exemplary embodiment. In the examples, if a lost status is detected, a prompt screen is displayed in accordance with the lost-status severity column 1040 of the lost-status-information table 1000. Specifically, if a lost status is detected, a setting item corresponding to a small value in the lost-status severity column 1040 is extracted, and a prompt screen corresponding to the setting item is displayed. However, prompt screens are classified (grouped), and superordinate-concept prompt screens are used for the display.

A message “Change password?” is displayed on a prompt screen 1300. A YES button 1302 and a NO button 1304 are also displayed. Specifically, if a setting item is of the first-rate lost status severity and matches one of setting items in a prompt-screen hierarchy table 1400, a prompt screen corresponding to the setting item is displayed.

FIG. 14 is an explanatory table illustrating an example data structure of the prompt-screen hierarchy table 1400. The prompt-screen hierarchy table 1400 has a lower-level classification column 1410 and a higher-level classification column 1420 and thus hierarchizes prompt screens. The lower-level classification column 1410 is used to store prompt screens in a lower-level group. The higher-level classification column 1420 is used to store prompt screens in a higher-level group.

The prompt-screen hierarchy table 1400 illustrated in the example in FIG. 14 has “Password change” classified as a higher-level group than a group of “Administrator password change” and “Apparatus password change”. A prompt screen for these is the prompt screen 1300 illustrated in the example in FIG. 13A.

Likewise, “Setting change” is classified as a higher-level group than a group of “Power-save mode change”, “Initial copy-set-value change”, and “Shortcut key setting”. A prompt screen for these is a prompt screen having content represented by “Edit setting-change-related matters?”.

If the YES button 1302 is selected on the prompt screen 1300, a prompt screen 1310 illustrated in the example in FIG. 13B is displayed. If the NO button 1304 is selected, a prompt screen 1320 illustrated in the example in FIG. 13C is displayed.

A message “Change administrator password?” is displayed on the prompt screen 1310. A YES button 1312 and a NO button 1314 are also displayed. Note that two prompt screens for “Administrator password change” and “Apparatus password change” may serve as a prompt screen for password change, but a prompt screen having a smaller value than the other in the lost status severity is displayed first. If the YES button 1312 is selected, a screen for administrator password change is displayed. If the NO button 1314 is selected, a screen for apparatus password change is displayed.

A message “Set shortcut key?” is displayed on the prompt screen 1320. A YES button 1322 and a NO button 1324 are also displayed. If the NO button 1304 is selected, the two prompt screens for “Administrator password change” and “Apparatus password change” belonging to the group at a lower level than the level of the prompt screen 1300 are skipped, and a prompt screen for “Shortcut key setting” of the third-rate lost status severity is displayed.

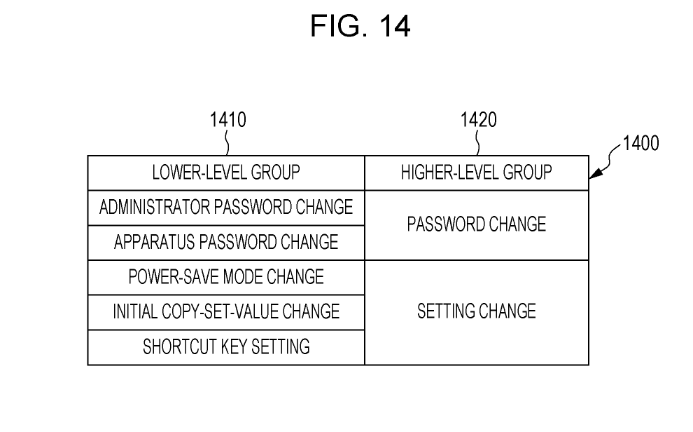

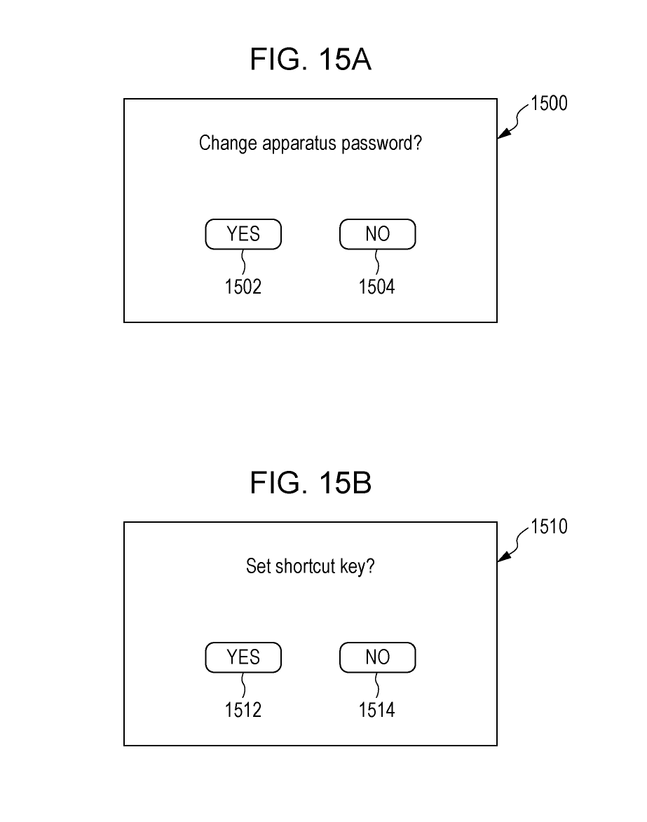

FIGS. 15A and 15B are explanatory diagrams illustrating examples of the process according to the exemplary embodiment. In the examples, if a lost status is detected, a prompt screen is displayed in accordance with the prompt condition column 1045 of the lost-status-information table 1000. In other words, if a lost status is detected, it is determined whether a condition for displaying a prompt screen in the prompt condition column 1045 is satisfied, and a corresponding prompt screen is displayed.

Specifically, history data regarding the entry point for the setting is held. When a user is lost after entering through the entry point, the prompt screen is displayed by using the prompt condition column 1045 of the lost-status-information table 1000. For example, multiple users intend to change an apparatus password and select Security settings (the appropriate menu item is Environment settings). In this case, if a user selects Security settings and then “Back”, a prompt screen 1500 is displayed as a prompt screen.

Note that one or more items wrongly selected by a user in the course of setting and the finally set item may be stored in association with each other. If another user wrongly selects the item likewise and then selects “Back”, a question regarding a screen in a layer immediately before the goal (intended setting item) may be provided.

If “Back” is detected as a user operation on the third layer screen, the prompt screen 1500 illustrated in the example in FIG. 15A is displayed. A message “Change apparatus password?” is displayed on the prompt screen 1500, and a YES button 1502 and a NO button 1504 are also displayed.

If the YES button 1502 is selected, a screen for apparatus password change is displayed. If the NO button 1504 is selected, a prompt screen 1510 illustrated in the example in FIG. 15B is displayed.

A message “Set shortcut key?” is displayed on the prompt screen 1510, and a YES button 1512 and a NO button 1514 are also displayed.

Selecting “Back” on the third-layer screen means that the second-layer screen does not provide user-friendly selection items. An item not found on the third-layer screen is preferentially displayed on the prompt screen.

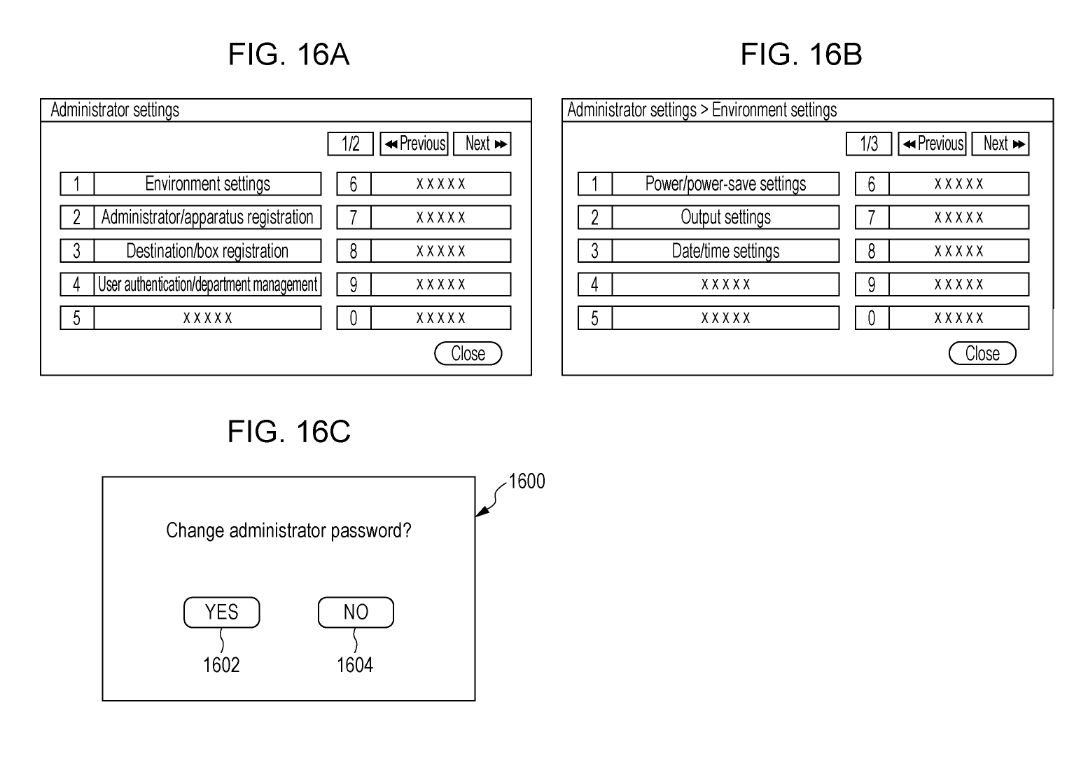

FIGS. 16A to 16C are explanatory diagrams illustrating examples of the process according to the exemplary embodiment. In the examples, if a lost status is detected, the prompt screen is displayed in accordance with the wrongly selected item column 1025 and the prompt condition column 1045 of the lost-status-information table 1000. In particular, past operations are used. Specifically, in the examples, a user intending to change the administrator password is lost and does not determine what to do.

The examples in FIGS. 16A and 16B illustrate the following situation.

The user thinks “Since the administrator password change typically belongs to Environment settings” and selects Environment settings. When looking at items in an Environment settings list, the user finds they have made a wrong choice and selects a “Close” button indicating returning to the previous screen.

A lost status is detected at this time, and a prompt screen 1600 is displayed in accordance with the wrongly selected item column 1025 and the prompt condition column 1045. A message “Change administrator password?” is displayed on the prompt screen 1600, and a YES button 1602 and a NO button 1604 are also displayed.

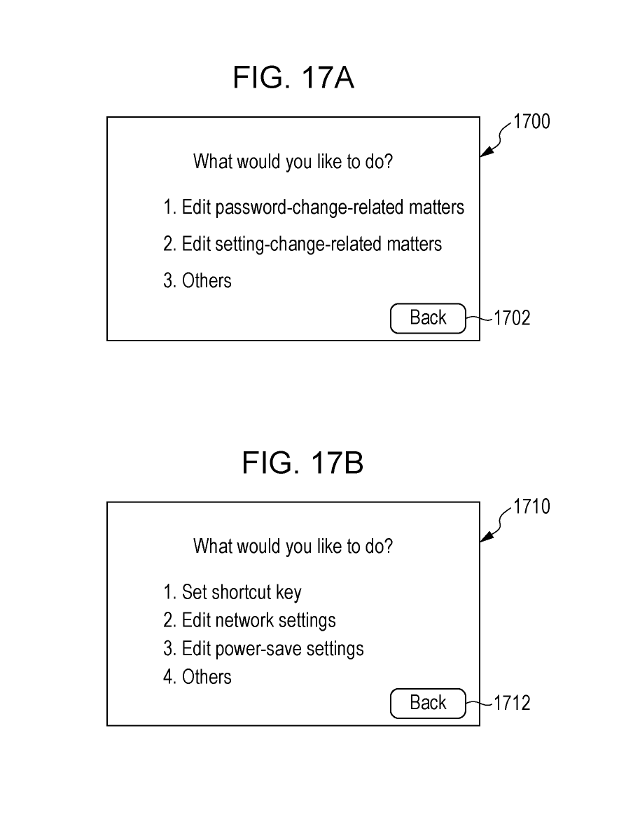

FIG. 17A and following drawings illustrate examples of prompting a user by using prompt screens each including a message “What would you like to do?” and an item list. Specifically, the order in which items are listed (an example of the order of items for a question) is changed in accordance with the content of the lost-status-information table 1000 and a user operation.

FIGS. 17A and 17B are explanatory diagrams illustrating examples of the process according to the exemplary embodiment.

On a prompt screen 1700, “What would you like to do? 1. Edit password-change-related matters; 2. Edit setting-change-related matters; and 3. Others” is displayed. A Back button 1702 is also displayed. In this case, since items related to password change have higher lost status severity than that of the others, “Password-change-related matters” is listed as the first item of the list. “Setting-change-related matters” rated second is then listed as the second item.

If “3. Others” is selected, a prompt screen 1710 illustrated in the example in FIG. 17B is displayed. On this screen, items having lost status severity rated lower than that of “Setting-change-related matters” are listed in order (in ascending order). Specifically, “What would you like to do? 1. Set shortcut key; 2. Edit network settings; 3. Edit power-save settings; and 4. Others” is displayed on the prompt screen 1710, and a Back button 1712 is also displayed.

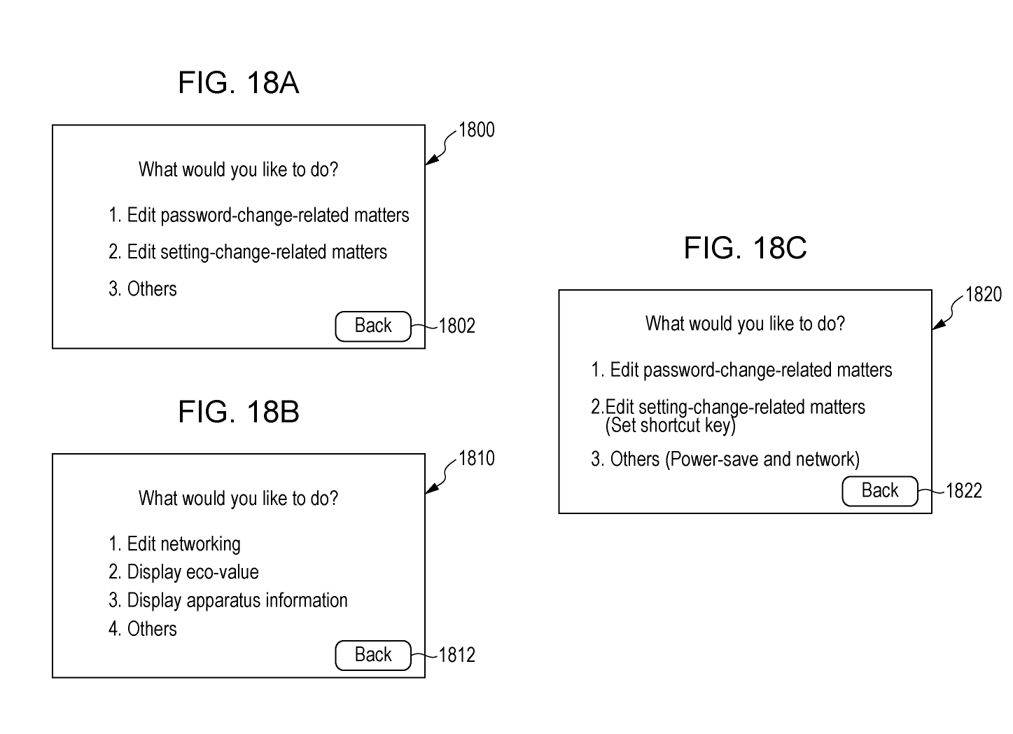

FIGS. 18A to 18C are explanatory diagrams illustrating examples of the process according to the exemplary embodiment. These illustrate a remedy for a case where a question on a prompt screen is not easy to understand.

In the examples, a user intends to set a shortcut key.

On a prompt screen 1800, “What would you like to do? 1. Edit password-change-related matters; 2. Edit setting-change-related matters; and 3. Others” is displayed, and a Back button 1802 is also displayed. Note that “Set shortcut key” is included in “Edit setting-change-related matters”. However, since the example in FIG. 18A does not provide an item corresponding to “Set shortcut key”, the user determines that “Set shortcut key” is not present and selects “3. Others”. In this case, a prompt screen 1810 illustrated in the example in FIG. 18B is then displayed. On the prompt screen 1810, “What would you like to do? 1. Edit networking; 2. Display eco-value; 3. Display apparatus information; and 4. Others” is displayed, and a Back button 1812 is also displayed. Since “Set shortcut key” is not present here, either, the Back button 1812 is selected.

If the Back button 1812 is selected, a prompt screen 1820 illustrated in the example in FIG. 18C is displayed. On the prompt screen 1820, “What would you like to do? 1. Edit password-change-related matters; 2. Edit setting-change-related matters (Set shortcut key); and 3. Others (Power-save and network)” is displayed, and a Back button 1822 is also displayed. As described above, if a “Back” button is selected on a prompt screen, items on the previously displayed prompt screen are displayed in detail. In the example in FIG. 18C compared to the example in FIG. 18A, “2. Edit setting-change-related matters” and “3. Others” are respectively changed to “2. Edit setting-change-related matters (Set shortcut key)” and “3. Others (Power-save and network)”.

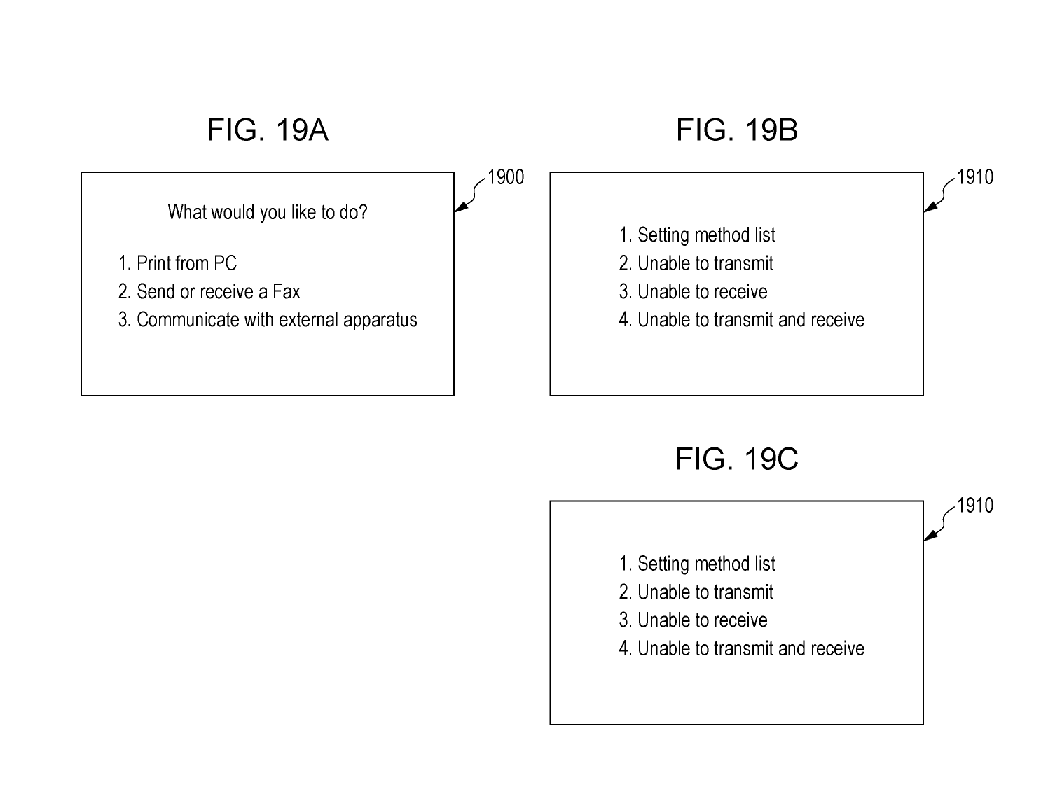

FIGS. 19A to 21 are explanatory diagrams illustrating examples of the process according to the exemplary embodiment. If a lost status is detected, a prompt screen 1900 illustrated in the example in FIG. 19A is displayed in accordance with the lost-status-information table 1000.

On the prompt screen 1900, “What would you like to do? 1. Print from PC; 2. Send or receive a FAX; and 3. Communicate with external apparatus” is displayed.

If “3. Communicate with external apparatus” is selected, a prompt screen 1910 illustrated in the examples in FIGS. 19B and 19C is displayed. On the prompt screen 1910, “1. Setting method list; 2. Unable to transmit; 3. Unable to receive; and 4. Unable to transmit and receive” is displayed.

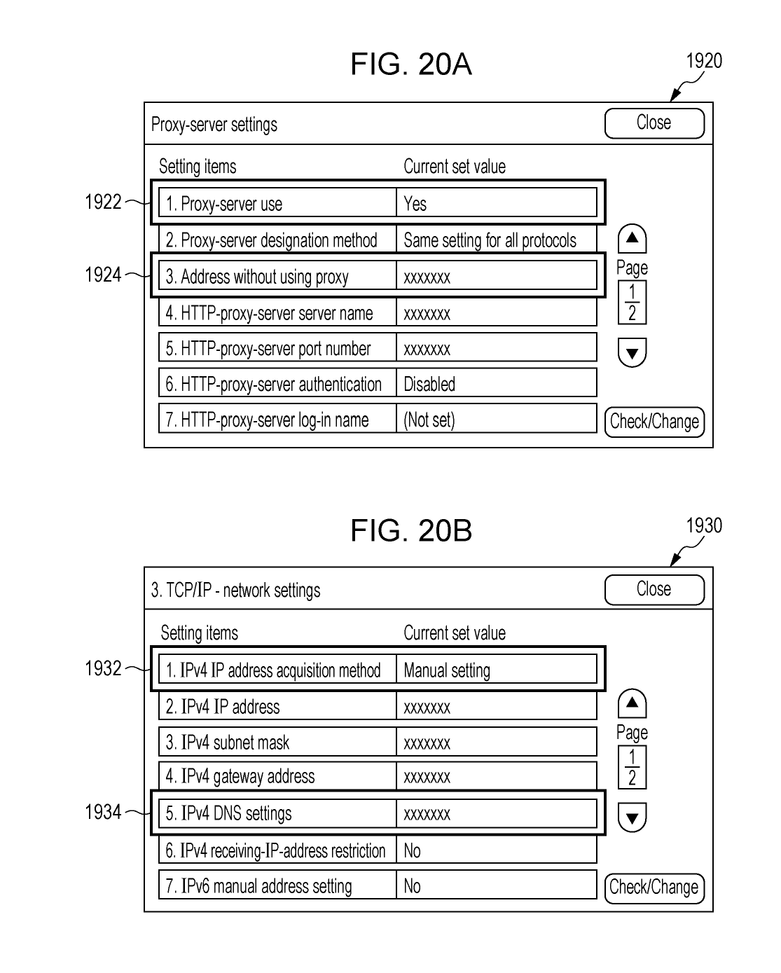

If “3. Unable to receive” is selected on the prompt screen 1910 illustrated in the example in FIG. 19B, a proxy-server settings screen 1920 illustrated in the example in FIG. 20A is displayed. A table of apparatuses setting items related to communication with external apparatuses is provided in association with the item “3. Unable to receive”, and the proxy-server settings screen 1920 is thus displayed on the basis of the table. On the proxy-server settings screen 1920, a proxy-server use field 1922, a proxy-server designation method field, an address without using proxy field 1924, a hypertext transfer protocol (HTTP)-proxy-server server name field, an HTTP-proxy-server port number field, an HTTP-proxy-server authentication field, and an HTTP-proxy-server log-in name field are displayed. If “Yes” set in the proxy-server use field 1922 is detected, a message indicating that setting “LocalHost” as an address in the address without using proxy field 1924 is a misoperation may be displayed. Setting LocalHost as an address is a frequently performed misoperation and is thus indicated. The fields are displayed on the basis of the lost-status-information table 1000 (in particular, in the prompt screen column 1050).

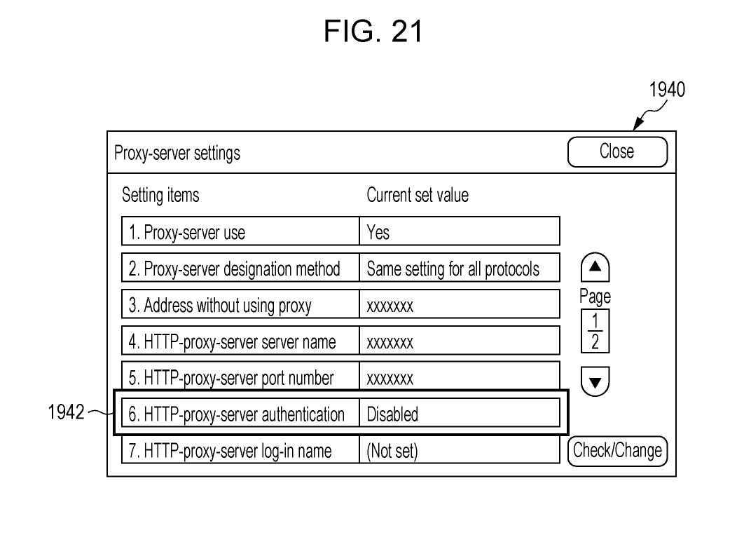

If “1. Setting method list” is selected on the prompt screen 1910 illustrated in the example in FIG. 19C, a transmission control protocol/Internet protocol (TCP/IP) network settings screen 1930 illustrated in the example in FIG. 20B is displayed, and a proxy-server settings screen 1940 illustrated in the example in FIG. 21 is subsequently displayed. The content of a settings screen for “1. Setting method list” is changed in accordance with the attribute of a user performing a setting operation (such as professionality, age, sex, and size of the company of the user). For example, in a case where the user is an administrator and where the size of the company is “large” (the user is highly likely to have a professional skill), a settings screen enabling detail settings is displayed. Since external connection needs a protocol and a proxy in this case, a protocol is first set on the TCP/IP network settings screen 1930, and a proxy is then set on the proxy-server settings screen 1940.

On the TCP/IP network settings screen 1930, an Internet protocol version (IPv)4 IP address acquisition method field 1932, an IPv4 IP address field, an IPv4 subnet mask field, an IPv4 gateway address field, an IPv4 domain name system (DNS) settings field 1934, an IPv4 receiving-IP-address restriction field, and an IPv6 manual address setting field are displayed. For example, a message “Replacement with old address occurs frequently” may be displayed, and a message such as “Change acquisition method to Manual” may be displayed as a remedy. Further, if even the remedy does not work, a message such as “Changing DNS settings to not be assigned by DHCP is likely to work” may be displayed. These are displayed on the basis of the lost-status-information table 1000 (in particular, in the prompt screen column 1050).

On the proxy-server settings screen 1940, a proxy-server use field, a proxy-server designation method field, an address without using proxy field, an HTTP-proxy-server server name field, an HTTP-proxy-server port number field, an HTTP-proxy-server authentication field 1942, and an HTTP-proxy-server log-in name field are displayed. For example, a message such as “Disable HTTP-proxy-server authentication field” may be displayed. These are displayed on the basis of the lost-status-information table 1000 (in particular, in the prompt screen column 1050).

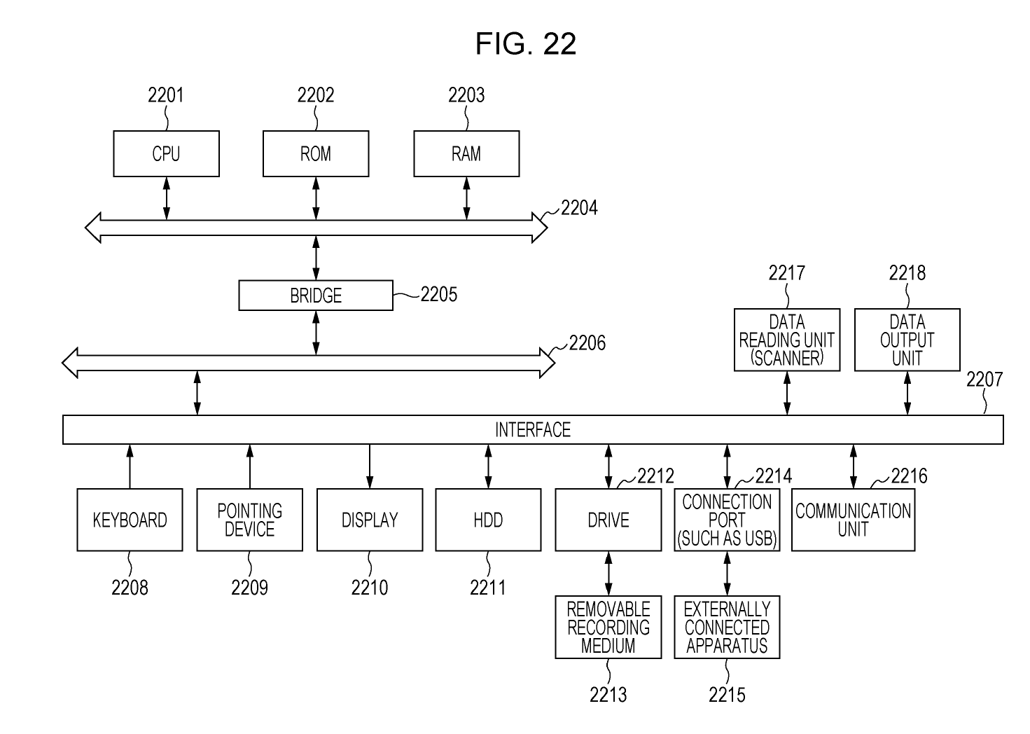

An example hardware configuration of the information processing apparatus according to the exemplary embodiment will be described with reference to FIG. 22. The configuration illustrated in FIG. 22 is implemented by, for example, a personal computer (PC) and is an example hardware configuration including a data reading unit 2217 such as a scanner and a data output unit 2218 such as a printer.

A CPU 2201 is a controller that executes a process in accordance with a computer program describing a sequence of executing the various modules described above for the exemplary embodiment, that is, the modules such as the receiving module 110, the control module 120, and the display module 160.

A read only memory (ROM) 2202 is used to store a program used by the CPU 2201, operational parameters, and the like. A RAM 2203 is used to store the program used when the CPU 2201 is run, parameters appropriately varying when the CPU 2201 is run, and the like. These components are mutually connected via a host bus 2204 including a CPU bus and other components.

The host bus 2204 is connected to an external bus 2206 such as a peripheral component interconnect/interface (PCI) bus with a bridge 2205 placed therebetween.

A keyboard 2208 and a pointing device 2209 such as a mouse are devices operated by an operator. A display 2210 has a liquid crystal display device, a cathode ray tube (CRT), or the like and displays various pieces of information as text information and image information. The display 2210 may be a touch screen or the like having both the functions of the pointing device 2209 and the display 2210. In this case, to implement the function of the keyboard, a keyboard (so-called a software keyboard or a screen keyboard) may be drawn on a screen (touch screen) by software without physically connecting the keyboard 2208.

A hard disk drive (HDD) 2211 has a hard disk (may be a flash memory or the like) incorporated therein, drives the hard disk, and records and reproduces the program run by the CPU 2201 and information. The hard disk implements the functions of the history-information storage module 130, the lost-status-information storage module 140, the prompt-screen-information storage module 150, and other modules. Further, the hard disk is used to store various pieces of other data, various computer programs, and the like.

A drive 2212 reads out data or a program recorded in a removable recording medium 2213 such as a magnetic disk, an optical disk, a magneto-optical disk, or a semiconductor memory that is attached to the drive 2212 and supplies the data or the program to the RAM 2203 connected to the drive 2212 with an interface 2207, the external bus 2206, the bridge 2205, and the host bus 2204 located therebetween. The removable recording medium 2213 is also usable as a data recording area.

A connection port 2214 is a port for connection with an externally connected apparatus 2215 and has a USB- or IEEE1394-compliant connection unit. The connection port 2214 is connected to the CPU 2201 and the like with the interface 2207, the external bus 2206, the bridge 2205, the host bus 2204, and the like located therebetween. A communication unit 2216 is connected to a communication network and executes processes of data communication with external devices. The data reading unit 2217 is, for example, a scanner and executes processes of reading documents. The data output unit 2218 is, for example, a printer and executes processes of outputting document data.

The hardware configuration of the information processing apparatus in FIG. 22 merely illustrates a configuration example, and the configuration of the exemplary embodiment is not limited to the configuration in FIG. 22. Any configuration that enables the modules described in the exemplary embodiment to be run may be employed. For example, at least one of the modules may be configured to run on hardware dedicated to the module (such as an application specific integrated circuit (ASIC)). At least one of the modules may be in an external system and be connected through a communication network. Further, multiple systems each serving as the system in FIG. 22 may be mutually connected through a communication network to work in cooperation with each other. In particular, the configuration may be incorporated in a mobile telecommunication device, a personal digital electronics, a robot, a copier, a fax machine, a scanner, a printer, a multifunction printer, or the like, aside from a personal computer.

Note that the program described above may be provided by using a recording medium having the program recorded therein and may be provided by using a communication unit. In this case, for example, the program described above may be regarded as an exemplary embodiment of the invention of a “non-transitory computer readable medium having a program recorded therein”.

The “non-transitory computer readable medium having a program recorded therein” refers to a computer readable recording medium having a program recorded therein that is used for installation, execution, distribution, and the like of a program.

Examples of the recording medium include: a digital versatile disk (DVD) supporting “DVD-R, DVD-RW, DVD-RAM, and the like” that are standards designated by the DVD Forum and “DVD+R, DVD+RW, and the like” that are standards designated in accordance with “DVD+RW; a compact disc (CD) such as a CD-ROM, a CD recordable (CD-R), or a CD rewritable (CD-RW); a Blu-ray (registered trademark) disc; a magneto-optical disk (MO); a flexible disk (FD); a magnetic tape; a hard disk; a ROM; an electrically erasable and programmable ROM (EEPROM (registered trademark)); a flash memory; a RAM; and a secure digital (SD) memory card.

Part or the entirety of the aforementioned program may also be saved on the recording medium to be stored or distributed. The program or part thereof may be transmitted through communication by using a transmission medium such as a wired network used for a local area network (LAN), a metropolitan area network (MAN), a wide area network (WAN), the Internet, an intranet, an extranet, or the like; a wireless communication network; or a combination of these. Alternatively, the program or part thereof may be transmitted by using carrier signals.

Further, the program may be part or the entirety of another program, or may be saved on a recording medium together with a different program. The program may also be divided to be saved on multiple recording media. The program may be saved in any manner such as by being compressed or encrypted, as long as the program is restorable.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives a setting operation performed by a user;
an acquisition unit that acquires prompt screen information based on lost status information generated from a history of the setting operation performed by the user; and
a display that displays a prompt screen corresponding to the prompt screen information if the setting operation received by the receiving unit is a specific operation.

2. The information processing apparatus according to claim 1,
wherein the lost status information is based on at least one of a screen on which a return operation is performed, a return operation count, and a time taken until setting completion or is based on a combination of any one of the screen, the return operation count, and the time.

3. The information processing apparatus according to claim 2,
wherein the display that displays the prompt screen if a return operation is performed on a screen in a specific layer.

4. The information processing apparatus according to claim 1,
wherein the display displays the prompt screen in a question form.

5. The information processing apparatus according to claim 4,
wherein an order of items for a question in the question form is changed in accordance with the lost status information.

6. The information processing apparatus according to claim 1,
wherein the prompt screen is one of hierarchized prompt screens.

7. The information processing apparatus according to claim 6,
wherein if the user refuses a prompt on the displayed prompt screen, the display skips a prompt screen belonging to a group at a lower level than a level of the prompt screen including the refused prompt and displays a subsequent prompt screen.

8. A non-transitory computer readable medium storing a program causing a computer to execute a process for information processing, the process comprising:
receiving a setting operation performed by a user;
acquiring prompt screen information based on lost status information generated from a history of the setting operation performed by the user; and
displaying a prompt screen corresponding to the prompt screen information if the received setting operation is a specific operation.
